(19) United States
(12) Patent Application Publication
(10) Pub. No.: US 2025/0085987 A1
(43) Pub. Date: Mar. 13, 2025

(54) SYSTEMS AND METHODS OF GENERATING ENTITY-LEVEL GRAPHICAL USER INTERFACES

(71) Applicant: Nasdaq Technology AB, Stockholm (SE)

(72) Inventor: Benjamin MARSHALL, East Sussex (GB)

(21) Appl. No.: 18/824,689

(22) Filed: Sep. 4, 2024

Related U.S. Application Data
(60) Provisional application No. 63/581,910, filed on Sep. 11, 2023.

(51) Int. Cl. G06F 9/451

(52) U.S. Cl. CPC G06F 9/451

(57) ABSTRACT

A surveillance system is provided that operates on data messages (or data based on such messages) that have been received from one or more different data sources. The surveillance system is configured to generate a graphical user interface and present the same to users in order to conduct surveillance and/or investigations into actions conducted by one or more clients/users/accounts that interface with those data sources.

### CROSS REFERENCE(S) TO RELATED APPLICATION(S)

This application claims priority to U.S. Provisional Application No. 63/581,910, filed Sep. 11, 2023, the entire contents of which are hereby incorporated by reference. This application is related to U.S. application Ser. No. 29/902,100, filed Sep. 8, 2023, the entire contents being incorporated herewith.

### TECHNICAL OVERVIEW

The technology described herein relates to graphical user interface systems. More particularly, the technology described herein relates to graphical user interface systems in surveillance platforms for detection and investigative insights into, for example, electronic trading platforms.

### INTRODUCTION

Electronic trading platforms produce vast quantities of data regarding the operations that have been performed on those platforms. Millions or billions of different messages, events, and signals may be processed on a daily basis. An important aspect for such platforms is monitoring activities on those platforms for illicit activity and the like. However, when there is such a vast quantity of data to shift through it can be difficult to present information to users in a way that provides contextual information as to whether a given action within a platform (or across multiple platforms) corresponds to some illicit activity.

Accordingly, it will be appreciated that new and improved techniques, systems, and processes are continually sought after—including in the area of graphical user interfaces, such as those that are used for surveillance monitoring and investigation.

### SUMMARY

In certain example embodiments, a surveillance system is provided that operates on data messages received from one or more different data sources. The surveillance system is configured to generate a graphical user interface and present the same to users in order to conduct surveillance and/or investigations into actions conducted by one or more entities (e.g., clients/users/accounts) that interface with those data sources.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features and advantages will be better and more completely understood by referring to the following detailed description of example non-limiting illustrative embodiments in conjunction with the drawings of which:

FIG. 1 shows a surveillance system that receives data of multiple different data sources according to some embodiments;

FIG. 2 is a flow chart of an example process for generating a graphical user interface that is presented as part of the surveillance system shown in FIG. 1 according to certain example embodiments;

FIG. 3 is an example graphical user interface showing illustrative features that may be provided by the surveillance system shown in FIG. 1 according to certain example embodiments, FIG. 3C is a color version of FIG. 3;

FIG. 4 is another example graphical user interface showing illustrative features that may be provided by the surveillance system shown in FIG. 1 according to certain example embodiments, FIG. 4C is a color version of FIG. 4.

FIGS. 5, 6, and 7 are screen shots showing different features of an example graphical user interface according to certain example embodiments.

FIGS. 50, 6C, and 7C are color versions of, respectively, FIGS. 5, 6, and 7; and

FIG. 8 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

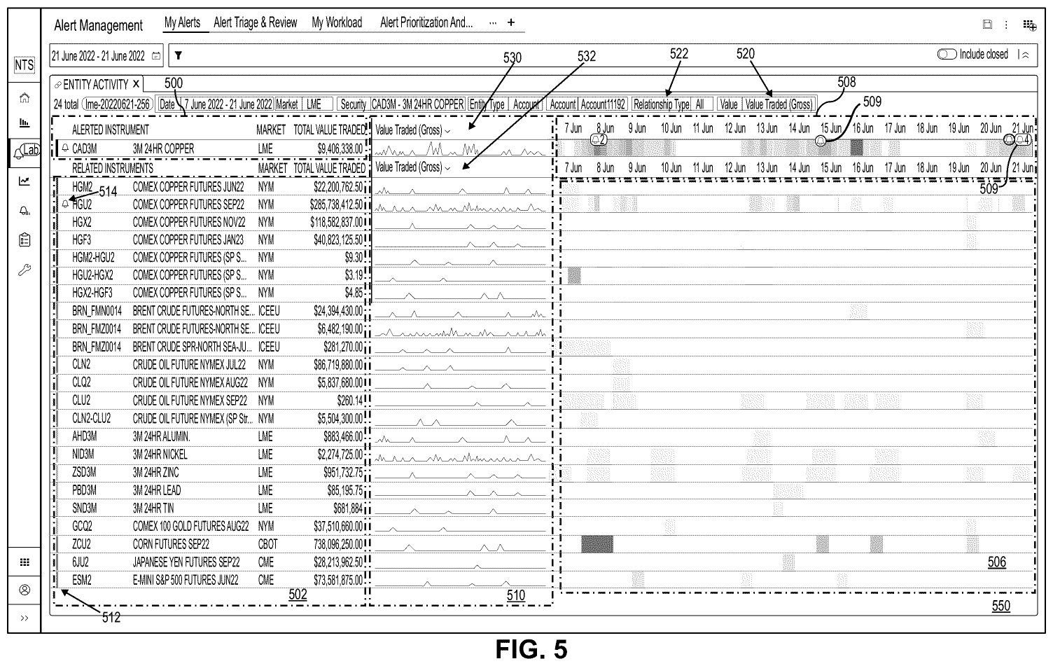

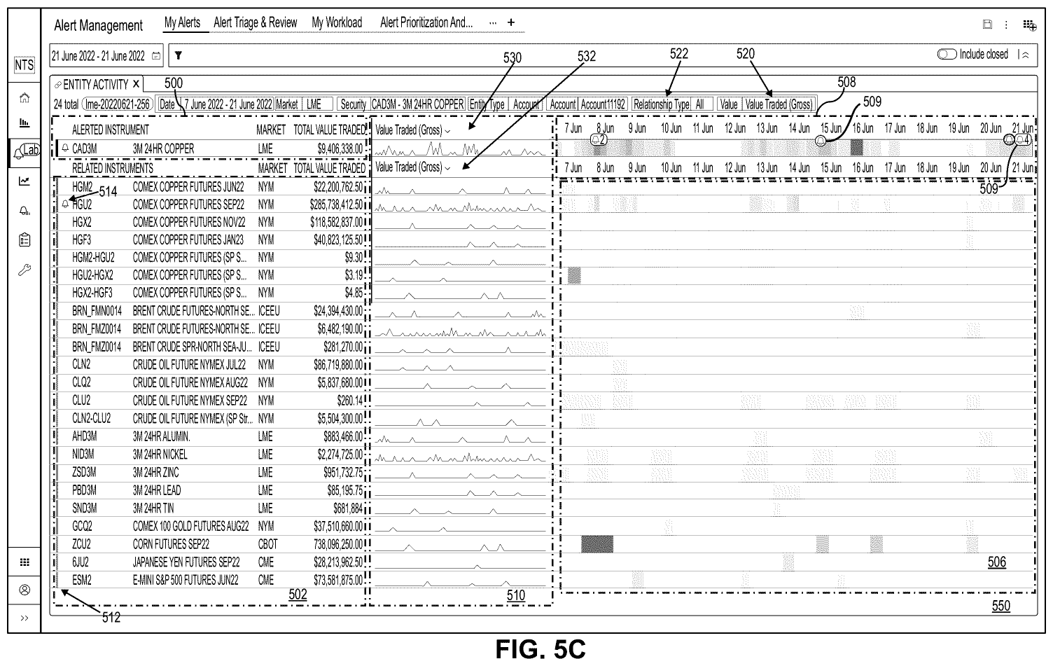

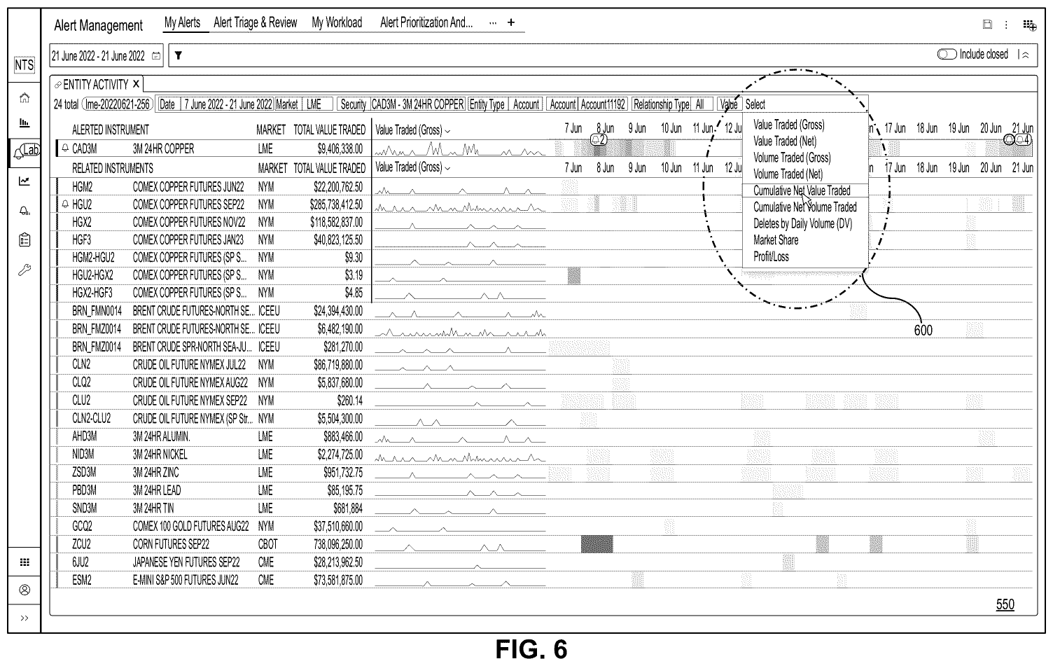

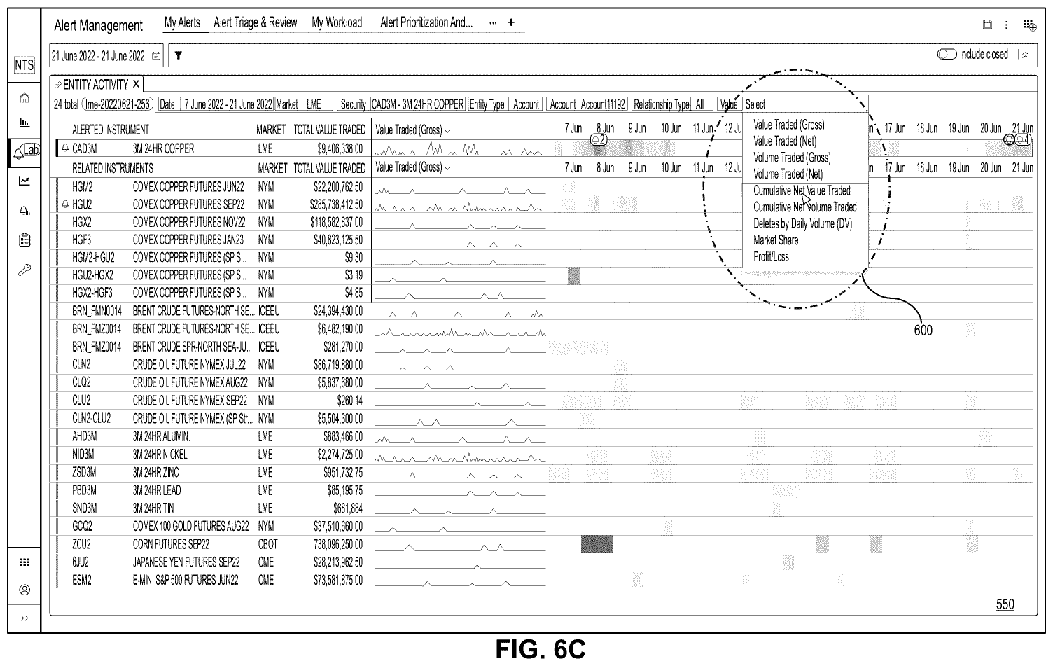

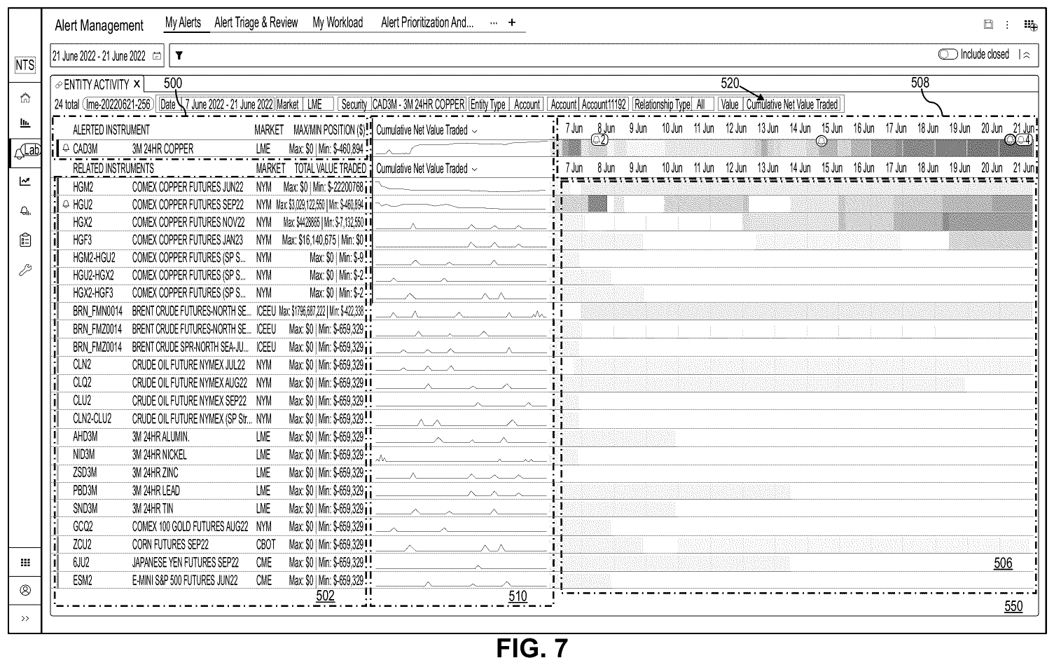

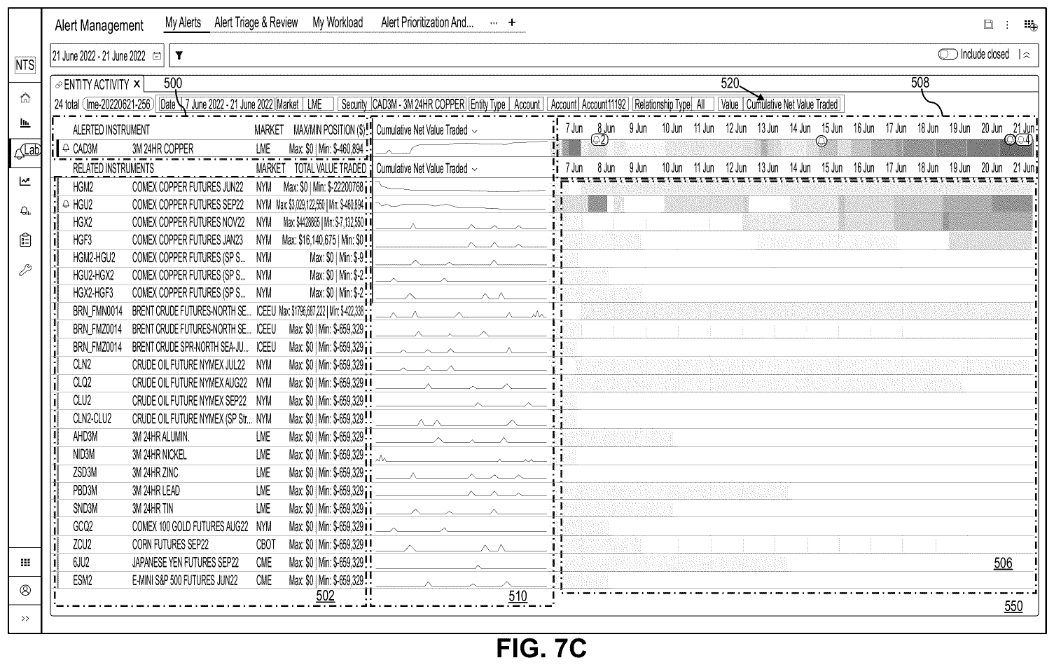

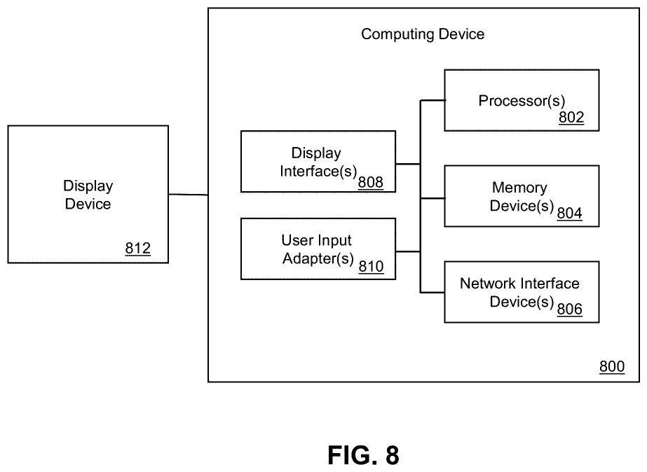

Sections are used in this Detailed Description solely in order to orient the reader as to the general subject matter of each section; as will be seen below, the description of many features spans multiple sections, and headings should not be read as affecting the meaning of the description included in any section. Some reference numbers are reused across multiple Figures to refer to the same element; for example, as will be provided below, the entity activity view 550 that is shown in FIG. 5 is also referenced and described in connection FIGS. 6-7.

### Overview

Billions (or more) of events are generated by computing systems every day. Such events exist in virtually every sector of the economy. Cybersecurity, traffic data, electronic exchange messages, weather data, and social media posts are a selection of various industries that generate large amounts of event data. And the number of events generated on a weekly, daily, or even hourly basis is likely to continue increasing.

However, due to the sheer volume of events being generated it can be difficult (if not impossible) for a person to manually assess such events—even with the help of computing systems. The techniques discussed herein provide new types of graphical user interfaces to present data on events to users in a way that provides contextual information as to whether a given action or event corresponds to, for example, some illicit activity. The techniques discussed herein allow for presenting events with additional contextual information regarding one or more entities (e.g., persons, organizations, etc.) that may be involved or associated with an event for which an alert was triggered.

In certain example embodiments, a surveillance system 100 is provided that allows for presenting a view of transactional event data from an entity-level perspective. An entity may be, for example, a user (e.g., a trader), a collection of users, an account (e.g., used by one or more users), or a firm that employs many different people that interact with one or more systems that generate transaction messages. The system operates on data messages received from one or more different data sources. The surveillance system is configured to generate a graphical user interface and present the same to users of the system in order to conduct surveillance and/or investigations into actions conducted by one or more clients/users/accounts that interface with those data sources.

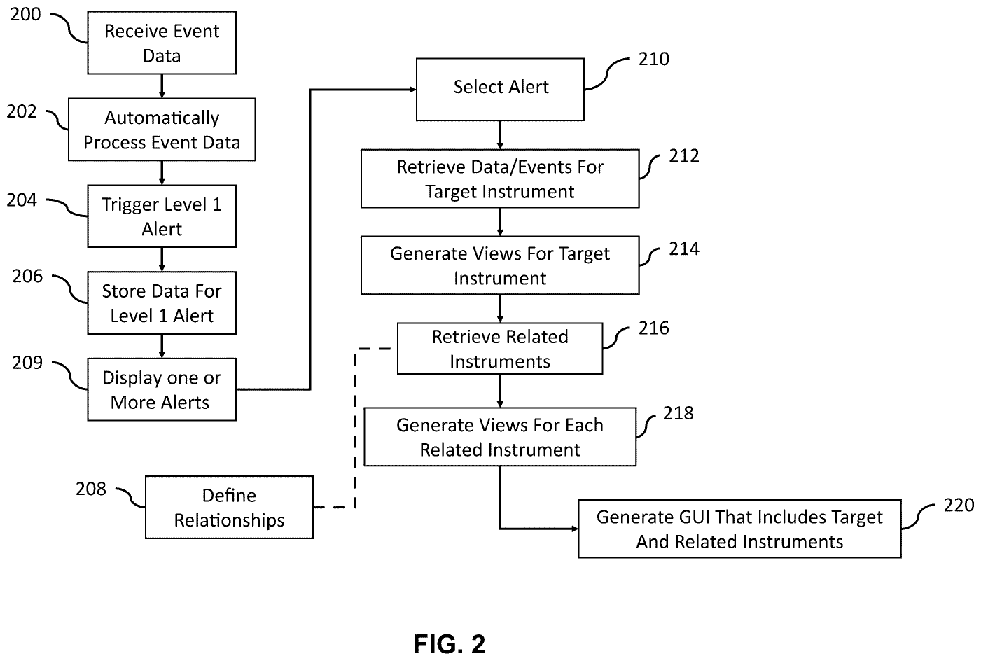

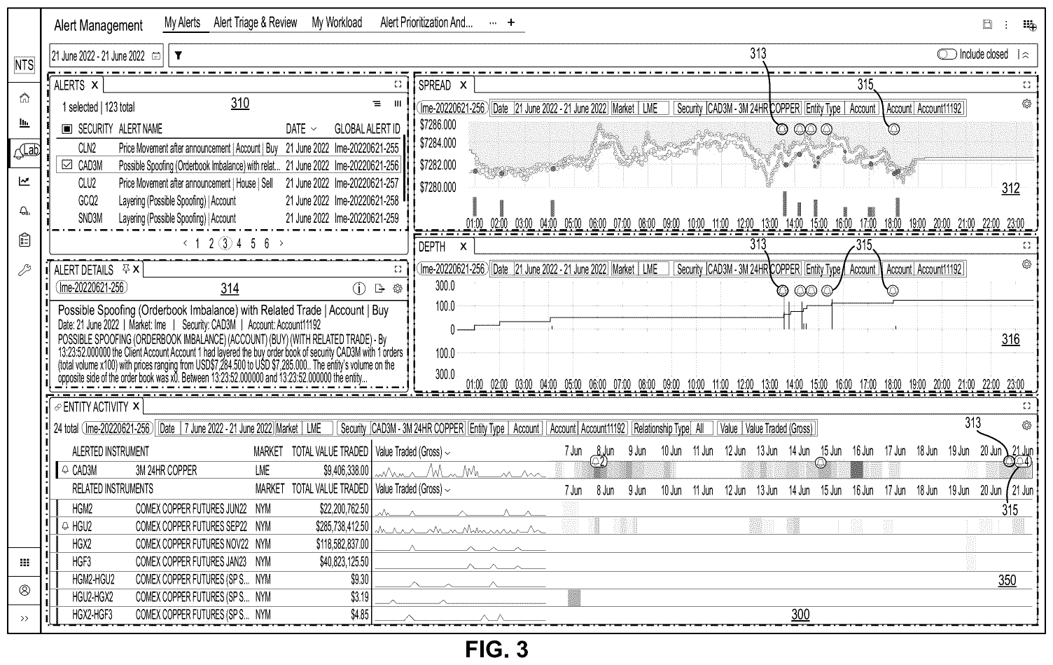

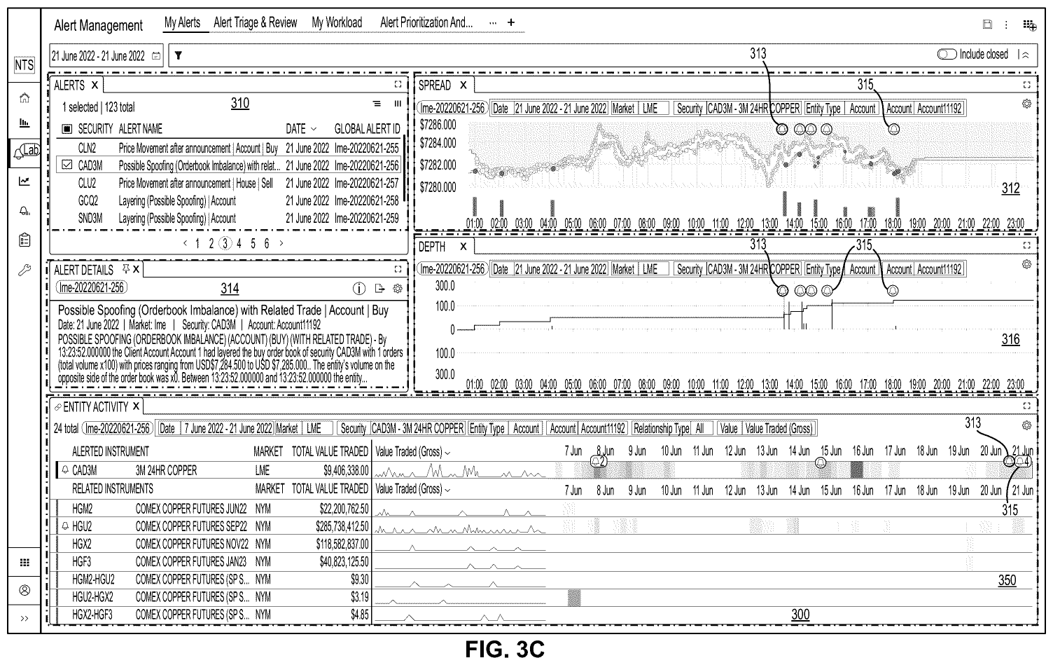

Processing that may be performed by system 100 is illustratively shown in the flow chart of FIG. 2. Example graphical user interfaces (and elements thereof) are discussed in connection with FIGS. 3-7. FIG. 8 shows an example computing device that may be used for any of the systems described herein, including the surveillance system 100, electronic trading platform, and/or a client device, where one or multiple such devices may be used to implement the system.

In certain example embodiments, surveillance system 100 is used to trigger (e.g., automatically, or manually) an alert when certain activity is detected as represented in the data that is received by system 100. When such an alert is triggered, system 100 provides users with a graphical user interface (e.g., via a web page, a thick client, a thin client, etc.) that includes contextual data for why the alert was triggered. This contextual data may be used to provide a broader, alternative, or more specific view of the data related to the why the alert was triggered. This may allow, for example, a user to determine if the triggered activity (or other activity represented in the data) is directly or indirectly associated with anomalous activity on the part of an entity (e.g., one or more users or other identifiers that may be separately identifiable by exchanges and other data sources).

In some instances, a user may be presented with a view of the alerted activity in context of all transactions for that entity (e.g., that is associated with the alert) during a trading day (e.g., all trades made by an entity). In some instances, additional user input may be processed (e.g., based on the information presented via the GUI) to thereby identify whether the alerted activity was part of a pattern of repeated activity (or attempts). The user may then flag the activity for further follow-up. In some instances, a user may use the information presented to them in the illustrative GUI to identify whether the alerted activity was within the bounds of, for example, trading objectives and strategy for the entity or represents a deviation from past behavior (e.g., a deviation from the norm).

The techniques discussed herein provide an entity level view (e.g., as shown in 550 of FIG. 5) for entity-focused surveillance perspectives within a GUI that a user can use.

In many places in this document, software (e.g., modules, software engines, services, applications and the like) and actions (e.g., functionality) performed by software are described. Examples include the alert module 118, data processing module 122, and GUI module 120. This is done for ease of description; it should be understood that, whenever it is described in this document that software performs any action, the action is in actuality performed by underlying hardware elements (such as a processor and a memory device) according to the instructions that comprise the software. Such functionality may, in some embodiments, be provided in the form of firmware and/or hardware implementations. Further details regarding this are provided below in, among other places, the description of FIG. 8.

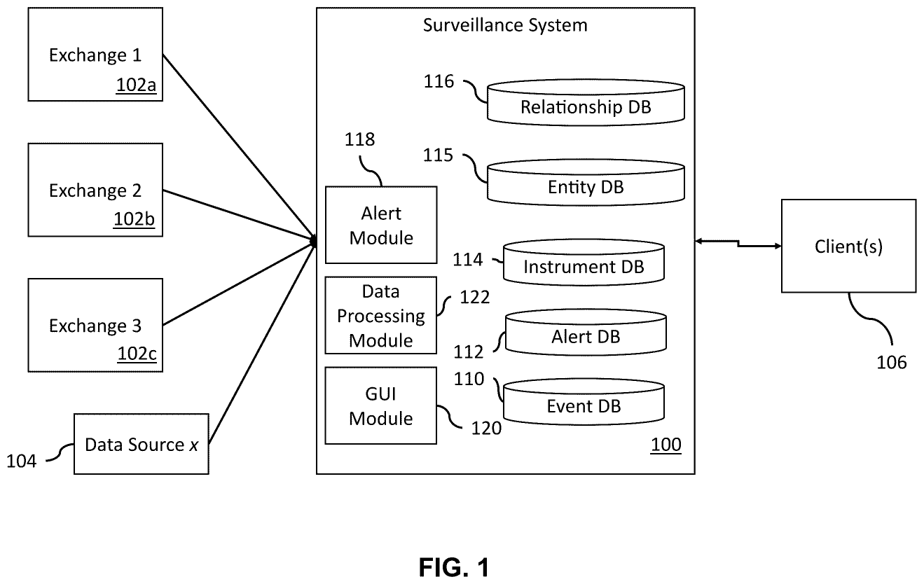

### Description of FIG. 1

FIG. 1 shows a surveillance system 100 that receives data of multiple different data sources according to some embodiments.

Some examples herein are provided in the context of electronic trading. However, the techniques herein may be applied in other contexts as well. Cyber security, traffic monitoring, and other sections in which entity level surveillance may be useful.

The surveillance system 100 receives data from one or more electronic trading platforms (also called exchanges herein) 102a, 102b, 102c. The data may include any or all of the messages (also called data transaction requests or data transaction request messages in certain examples) processed by such platforms, and/or summary data of such messages. It will be appreciated that this data may include both messages communicated to/from other computer systems that communicate with the exchanges and internal data messages generated by the exchange. In some examples, the data may include, for example, drop copy messages that may then be used to reconstruct an order book state at a given point in time.

One or more of the exchanges may maintain an order book data structure (which may also be referred to as an “order book,” “central limit order book,” “CLOB,” “CLOB data structure,” or similar) for one or more instruments (also called securities or resources herein). Each instrument may be identified (e.g., uniquely) using an identifier (e.g., CAD3M). The exchanges may also each include a matching engine that maintains and/or has access to the order book data structure to store pending (e.g., previously received) orders that are available for matching against newly received or incoming orders. A separate order book may be used for each asset (e.g., identified via a unique identifier) that is traded on an electronic trading platform. For example, if two different cryptocurrencies are traded on an electronic trading platform, the platform's matching engine will maintain an order book for each of the two cryptocurrencies.

An order book is often structured as including two list data structures, with one of the list data structures for the buy orders and the second list data structure for the sell orders; each list in the order book may be referred to as a “side” of the order book, and the order book data structure can be referred to as a “dual-sided” data structure. Each, or both, of these lists may be sorted using a sorting algorithm that takes into account one or more properties of the orders within the order book- or other data. For example, the orders may be sorted based on timestamps that reflect when an order is received. Other more complex sorting algorithms are also possible. In many electronic trading platforms where an order book for an asset is used, processing performed by a platform's matching engine may include use of the order book, by e.g., comparing the characteristics of a newly received order to the characteristics of contra-side orders stored in the order book for the asset to determine if a match can be made.

The order book data that is maintained by each exchange may be reconstructed by system 100 in order to present a view of that order book as part of GUI to a user of the system 100. An illustrative example of this is provided in windows 312 and 316 of FIG. 3 that respectively show the spread and depth of the order book for the CAD3M instrument.

Data may also be received from other data sources 104 depending on application need and the type of data being analyzed by system 100. As an illustrative example, system 100 may receive data from a blockchain (e.g., bitcoin, Ethereum, etc.). As another example, system 100 may receive data directly from clients that communicate with exchanges 102a, 102b, 102c. As another example, data may be received from regulatory agencies or third-party data providers/aggregators, etc.

In any event, the data received by system 100 may be stored into event database 110. This data may correspond to the “raw” data that is received from each data source (whether exchanges or otherwise). Each record that is stored may correspond to an event, message, change in state (e.g., for an order book from one state to another other, such as by adding or removing an order from the order book), or other data that is received from one or more of the data sources (exchanges 102 and other data sources 104).

The data that is received by system 100 may then be stored to event DB 110. The events for which data is received may relate to instruments that are equities, fixed income, commodities, benchmarks, derivatives, foreign currency transactions, energy/power rates, over the counter transactions, digital assets (e.g., NFTs or fungible tokens), cryptocurrency, swaps, offsets (e.g., for carbon and the like). In some examples, the techniques discussed herein may apply to other types of events, from cybersecurity data (e.g., events regarding network traffic or events generated by user devices), to traffic data, to social media data (e.g., posts, reactions, and other interactions that may be performed on social media sites), to weather data (e.g., events from sensors), and the like.

Other databases in system 100 include alert DB 112 that stores generated alerts, an instrument DB 114 that stores data related to the different instruments (e.g., resources) that the events are related to, an entity DB 115 that stores data on the different entities associated with the events (e.g., who submitted an order or the like), and a relationship DB 116 that stores relationship information between different instruments. Other databases may also include relationships between entities or different accounts, users, or the like that are associated with the event data.

In general, an entity may be associated with a single user, or a group of users. For example, an entity may be associated with an organization, with all employees being associated with the entity. In some examples, an entity may include further entities (e.g., different groups or divisions within a larger structure). The techniques herein allow for flexibly defining an entity—and thus the scope of which events, resources, messages and the like will be subject to surveillance (e.g., displayed in the illustrative GUIs discussed herein). Indeed, in some examples, ad hoc entities may be generated to provide an entity level view of seemingly unconnected users (or other such ad hoc defined entities).

System 100 includes multiple different modules for processing and generating views of the data stored within the database. These modules allow for surveillance of the data communicated to the system, and data sources that communicate that data to system 100. Among the modules that may be included with system 100 is an alert module 118, a GUI module 120, and a data processing module 122.

The alert module 118 is configured to process the data that is in the event DB 110 (or data that is based on that data) to determine whether one or more anomalous events are detected. If such an occurrence is detected, then an alert is generated that includes information on the instrument in question, the data used to trigger the alert, and other data as needed. In some examples, the alert module 118 is completely automated. In other instances, the alert module 118 may include manual review of data. In some examples, the alert module 118 may use trained machine learned models to detect anomalous activity within the data of one or more instruments. Alerts that are generated may be stored into alert DB 112. Window 310 in the GUI shown in FIG. 3 shows a list of multiple such alerts that have been generated.

The data processing module 122 is used to, among other things, generate additional data from the data included in the event DB 110. For example, the data processing module 122 may be used to reconstruct an order book state for one or more instruments using the data in event DB 110. This may be performed by generating a snapshot of the order book using the events for a given resource (e.g., instrument) to recreate the state of the order book at a given time (e.g., a time indicated for a given event).

As other examples, the data processing module 122 may be used to generate averages, totals, and other data from the data stored in event DB 110. In some examples, this additional data may be stored in a database and/or used as a cache. Such data may be generated on a nightly or other basis and may allow the data to be quickly presented to reviewers on the following day (or other time period).

GUI Module 120 is a module that is used to generate the different graphical user interface elements that are described herein. For example, to generate the charts and other data that is shown in FIGS. 5-7.

Clients 106 are computing devices (e.g., the computing device of FIG. 8) used by users that are using system 100 to review, surveil, and/or investigate the activity that is represented in the data for the instruments. In general, such users are investigating the data stored by system 100 for anomalous or illicit activity.

### Description of FIG. 2

FIG. 2 is a flow chart of an example process for generating a graphical user interface that is presented as part of the surveillance system shown in FIG. 1 according to certain example embodiments.

At 200, event data is received from one or more of the data sources that communicate with system 100. In certain example embodiments, the reception of data is a bulk data transfer that may occur, for example, at the end of an operation day (e.g., after the close of regular trading hours for an exchange). In other examples, the data that is transferred may be a real-time data feed from the data sources. As an illustrative example, the event data may include the ITCH data feed from the Nasdaq exchange.

At 202, the event data that has been received is processed. As noted above, this process may be run against the data in order to identify potential anomalous activity. In some examples, this process may be automatic. In other examples, the process may include users manually identifying such activity. In some cases, the processing may involve both manual and automated processing.

At 204, an alert is generated for each instance within the data that is recognized as anomalous.

At 206, each alert that is generated is then stored in the alert database 112. It will be appreciated that alerts generated/stored at 204/206 may be considered level 1 alerts. Such alerts may provide for an initial view of certain types of potentially anomalous activity.

At 210 one or more alerts are displayed or otherwise made available. An example of this may be window 310 in FIG. 3 that shows a list of alerts. In some examples, alerts that are displayed may be automatically selected and in other examples all alerts may be displayed. In certain cases, this may involve presenting, for example, alerts as part of a GUI and allowing a user to select each alert and the context associated with that alert. In certain examples each alert will include one or more additional identifying pieces of information. Such information may include the instrument or entity that triggered the alert (e.g., the target instrument), the underlying data that forms the basis of the trigger, and/or any account information associated with the events/data that triggered the alert. For example, if there is activity identified as anomalous for ticker ABCDE, then that instrument will be identified as the target instrument for the alert.

In certain cases, alerts can be triggered based on suspicious orderbook activity taking place for one instrument. In cases where multiple instruments are involved, (e.g., related instrument alerts), the suspicious orderbook activity is usually present only on the lead leg′ with trades executed on the ‘profit leg’ looking inconspicuous in comparison. In certain examples, the instrument in which the suspicious activity takes place then can default to being the target instrument (also called the primary instrument herein) in the entity view discussed below, with all other instruments that a given entity has activity being referred to as related to herein as secondary instruments.

In certain example embodiments, the processing from 204/206 and 210 may be asynchronous in nature. For example, the processing for generating level 1 alerts may be performed automatically once the underlying data is received whereas the processing for reviewing such alerts may be performed later.

At 212, data for the target instrument is retrieved. This data may be retrieved directly from the event database, cache storage (e.g., which includes data generated from the data processing module 122), generated on-demand, or some combination thereof in connection with the alert. In some examples, once an alert is generated, then additional data related to that alert may be automatically generated and stored to a cache for future retrieval by a reviewer.

In some examples, data in the cache may be stored for the past two weeks. In other examples, a lookback period of 1 month or more may be used. In such cases, the data that is generated for each instrument may be compiled at the end of each trading period (e.g., each day) and then correspondingly updated to the cache to thereby be ready for analysis the following day.

At 214, views for the data of the target instrument may be generated. This may include generating graphs and other data in preparation for presenting the data to a user as part of a GUI. The data used in the windows (e.g., 312, 316, etc.) shown in FIG. 3 are examples of the views that may be generated.

One of the aspects of the techniques described herein is allowing users to see a more comprehensive or contextual view of data related to what triggered the alert. Accordingly, in certain examples, relationships between the instrument that is associated with the triggered alert (e.g., the target instrument) and other instruments (e.g., related instruments) that are related to the alert may be defined. Accordingly, at 208, one or more relationships may be defined between each instrument and another instrument.

Relationships between instruments may be automatically defined or manually defined. Examples of different types of defined relationships include those in the same product family (e.g., for the same product but on different options dates), correlated instruments (e.g., the name of the instrument includes the same name-such as “Gold”), and other types of relationships between instruments. Secondary instruments that do not have a defined relationship with a primary instrument may be classified/shown with an “undefined” relationship. In some examples, undefined relationships may include those instruments that a given user (e.g., a trader) or other entity (referred to as an “account” herein”) has operated within a given day. Thus, for example, if the triggered instrument is a gold future, then data for all other related instruments may be displayed. All instruments that the entity has activity associated therewith (e.g., an oil future or APPL stock, etc.) may be classified as undefined if it does not fall within one of the defined relationships. An illustrative list of different defined relationships may be: 1) Same product family (Related instrument); 2) Correlated instrument; 3) Associated instrument; 4) Constituent instrument; 5) Variant instrument; and 6) undefined.

In some examples, the relationship between instruments can be determined based on relationship mappings that are used by the alert module 118. Where a mapping exists, all related, correlated, and associated instruments are specified as such. If no such relationship is defined, then a given instrument will be determined to be “undefined” to a target instrument.

In any event, at 216, the instruments that are related to the target instrument may be retrieved. As needed, any additional data on the related instruments may be generated (e.g., similar to as performed at 212).

At 218, the views for each related instrument may be generated. This may include the data that is needed in connection with each row for a corresponding related instrument as shown in FIGS. 5-7 (e.g., 532 and the heatmap values in 506).

At 220, a GUI is generated that includes both the target and related instruments. This is then communicated or otherwise presented to a user on a display device. As noted herein, the presentation of the GUI may occur via a web browser, thin client, or thick client application.

FIGS. 3-7 below illustrate different aspects of the GUI that may be used to present contextual information to a user.

### Description of FIG. 3

FIG. 3 is an example graphical user interface showing illustrative features that may be provided by the surveillance system shown in FIG. 1 according to certain example embodiments.

Screen 350 includes an alert window 310 for displaying one or more alerts to the user. The user can select any of the alerts within the window. Each record within the window 310 may be based on the alert database 112 and include the instrument that is associated with the alert (e.g., CAD3M), a description for why the alert was triggered, the date when the alert was triggered, and unique identifier for the alert within system 100. The alerts shown in alert window 310 may be generated via the alert module 118. In some examples, the alerts shown in the alert window 310 may be those that are, for example, “level one” alerts or may be those that have been escalated (e.g., level 2 alerts). In some examples, users of the system my see alerts assigned to them. Thus, for example, a first reviewer can be presented with all of the initial alerts (e.g., a level 1 alert) and may escalate a given alert (or multiple alerts) to a second user. The alerts displayed for the second user may then include those escalated alerts (e.g., a level 2 alert or the like).

Window 314 includes a comprehensive description of what triggered the alert (e.g., the details of the alert).

Windows 312 and 316 include graphs for different data related to the instrument (e.g., the target instrument) to which the selected alert is related. Window 312 is a graph of the spread for CAD3M while window 316 includes a graph of the depth of the order book for CAD3M. The graphs shown in 312 and 316 may be with respect to time, with the horizontal/x-axis being time and the vertical/y-axis being an amount (e.g., the depth of an order book or the spread). By presenting graphs in this manner, users can observe how various characteristics for an instrument change over time.

Also included in these two windows are icons 313 that identify when the selected alert occurred. Other alerts for this instrument (or entity) may also be included. In the example shown in FIG. 3, there are 4 additional icons 315 that correspond to further alerts for this instrument. These are shown by the bell icon within the graph. A user can click through each of these alerts to see additional details (e.g., in 314) on the alerts as needed and/or automatically select the alert from the alert window 310. The alerts may be provided in connection with the currently focused entity, or may be otherwise defined (or global and displaying all alerts for this instrument for all entities).

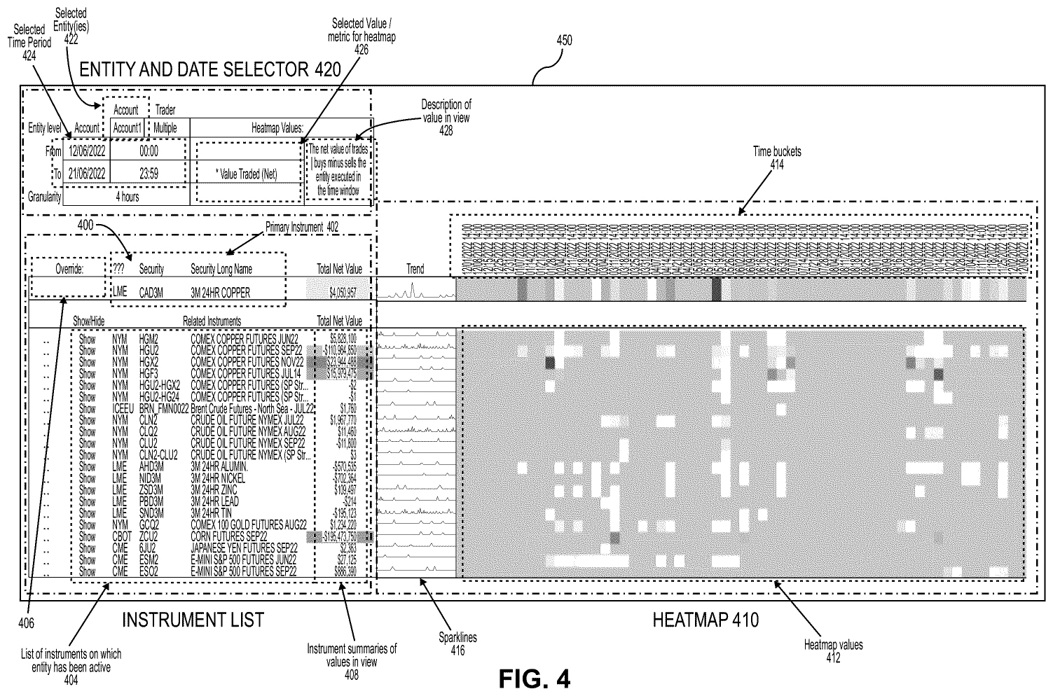

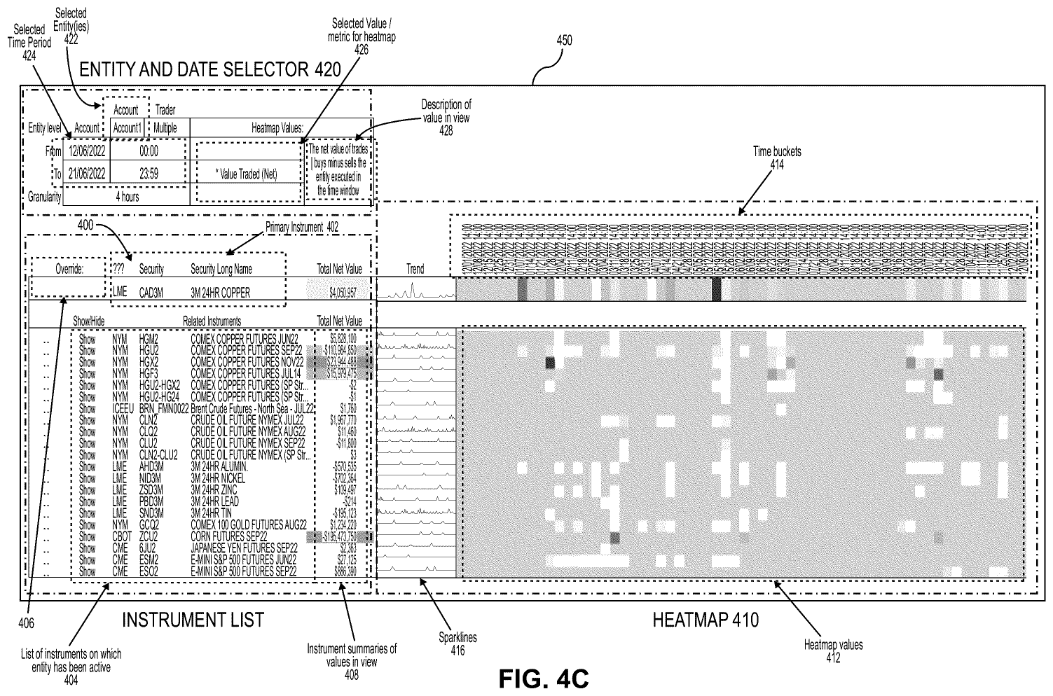

Screen 350 also includes an overview window 300 of the activity for this selected entity for the target instrument and any related instruments. Additional details of the overview window 300 are discussed in connection with FIGS. 4-7 below.

In certain examples, the overview window 300 (and the functionality associated with this GUI) may allow a reviewing user to see coordination over a period of time (e.g., between different instruments and/or different traders/users) by seeing how they are building and selling positions over a period of time.

The information presented in such views (as shown in FIGS. 3-7) can also allow reviewing users to more quickly classify alerts as non-problematic (e.g., one position was being hedged). The techniques herein may allow for the presentation of this data in a more contextual manner and allow users to identify false positive alerts more quickly. For example, the contextual information may allow users to identify that an alert was the result of a hedging strategy, arbitrage, or the like. The techniques herein (e.g., as discussed below) provide users with the ability to both see more contextual data for an entity and the instruments that the entity has activity in. This may also give functionality for drilling down on the underlying data (e.g., that caused the alert).

It will be appreciated that the techniques, features, and the like discussed in connection with FIG. 4 may be applied to the screen shots and GUI shown in FIGS. 3 and 5-7. Similarly, the techniques, features, and the like discussed in connection with FIGS. 3 and 5-7 may be applied to FIG. 4. It will also be appreciated that the while the examples discussed herein are provided in connection with data generated by exchange computer systems and data associated therewith, that the techniques may be applied in other contexts that can benefit from displaying additional data (e.g., context) in connection with the data for which an alert was generated. Illustrative examples of other types of data may be data generated for cybersecurity monitoring, social media data, traffic data, and others.

### Description of FIG. 4

FIG. 4 is another example graphical user interface showing illustrative features that may be provided by the Surveillance System 100 shown in FIG. 1 according to certain example embodiments. The GUI shown in FIG. 4 may correspond to window 300 that is part of the screen 350 shown in FIG. 3.

GUI 450 includes a plurality of different graphical elements that allow users to enter/select data fields and be presented with data values associated with a target entity and possibly any related entities and then view instruments that have been transacted by that entity.

GUI 450 includes an entity and data selector 420. This window includes selectable fields that allow a user to define a date range 424, an account 422, and to select a value or metric 426 that will be calculated and then displayed for a primary instrument and its related instruments below. The description of the selected metric may then be displayed in information box 428.

In certain example embodiments, accounts may be composed of one or more users. In other words, each event that is processed by the system 100 may have a user identifier that is associated with that event. The user may be an individual person or may, in some cases, be a computer program (e.g., an automated process). Accounts are then generated based on users. In some examples, accounts may be dynamically defined. For example, an investigating user may create a new account that includes two seemingly unrelated users and define the activity of those two users as a single account. The various events, instruments, and the like may then be presented in the GUI as a single account. In other examples, accounts may be automatically generated or set. For example, a given client (e.g., a bank) may provide a list of users associated with that client. These may all be grouped under a single account (which may be an entity) to allow correlation of users (e.g., employees) of the bank. Such users may be separated from other non-bank employees (e.g., traders or bank customers) that use the services of the bank to conduct transactions with one or more exchanges.

The ability to dynamically and flexibility allow investigative analysts to see activity across two users or trader IDs (e.g., known to be associated with the same entity as well as traders on the same desk who are suspected of colluding with each other) can increase the flexibility of the contextual data presented to the user via the GUI.

In certain examples, an account (e.g., a login used to access an exchange) can be serviced by more than one trader, and a trader can work on behalf of more than one account. In some examples, users can be presented with a view of different traderIDs to see which traders were servicing the selected account and filter by these traders in order to help narrow the scope of their review. Conversely, a user may use the entity view to focus on a specific traderID and not an account. Accordingly, the entity selector 420 can be used to show what accounts the trader was working on behalf of—e.g., to potentially facilitate review of the alerted activity for that trader (or the clients that the trader was working for).

In certain example embodiments, each trader ID, account ID, or other identifier that is associated with a particular event, activity, transaction, or trade that is being analyzed may be referred to as a “transacting identifier”, a “transacting context”, herein. In other words, the party associated with the transaction, event, or other activity may be identified with a corresponding identifier and this identifier may be used in connection with generating, maintaining, or using the entity-based views herein (e.g., to retrieve other events or the like that are associated with that transacting identifier).

GUI 450 includes a window 400 that includes a list of instruments 404 that are associated with the target instrument 402. The target instrument is selected based on the currently selected alert. Additional instruments 404 are shown in a list and may be those associated with the currently selected entity (e.g., the account from 422). The instruments that are shown in 404 may be listed as those that are active for the currently defined time period (e.g., 424). “Active” may be any trades and/or may include any activity that modifies or hits an order book for the subject instrument within an associated time frame. Other ways to define “active” may also be used depending on the nature of the instrument (e.g., Ethereum, or carbon offsets, etc.). As discussed in connection with FIGS. 5-7, color coding or other indicators may be used to differentiate between different types of relationships to the target instrument (e.g., family, correlated, unrelated, etc.).

In certain examples, the instrument list 404 may allow users to view those other instruments and markets that the entity been actively participating in and/or what other instruments are related to the target instrument.

Each of the instruments (both shown as the target instrument 402 and the instruments shown in list 404) includes a summary 408 of the values that have been selected via 426. In FIG. 4 this is the “Total Net Value” in connection with the traded value metric.

Another component of GUI 450 is heatmap 410 that displays a heatmap over a plurality of time buckets, spans, intervals, or windows. The time buckets 414 are shown above with the heatmap view of the selected metric displayed in 412. The color of the heat map values may be based on which metric is being shown. In some examples, red is negative, and green is positive. In other examples, red may be, for example, an aggressiveness measure while green may correlate to more passive action. In certain example embodiments, the color values may correspond to the intensity/nature of this particular metric and how it has changed over the period in view.

In certain example embodiments, there may be a fixed number of time buckets and the length of time for each bucket may be automatically determined. For example, there may be 60 time buckets (e.g., always shown), with the timespan of each bucket covering 1/60^{th} of the time period defined by 424. Accordingly, as the time period is adjusted, the interval of time covered for each bucket may be automatically adjusted to reflect the data for a new corresponding time span. This functionality thus allows reviewing users to go from viewing a 2-week period to a 1 day, or 1 hour period (e.g., 1-minute buckets)—while still maintaining the same or similar view of 60 visual datapoints.

Included with heatmap 410 is a sparkline view 416 of the data shown in 412. This view provides a trend line over the time period defined from 424 and can allow for more easily noticing subtle (or not subtle) changes in a given metric. The sparklines 416 and the heatmap 412 are shown for both the primary instrument and also for those instruments in list 404.

Another element included in GUI 450 is an override feature that allows users to view different metrics side-by-side. More specifically, the override selector 406 allows a user to select a different metric than that shown/selected via the selected metric 426. The override selector may display, for example, a drop-down list of various other metrics that may be selected by a user. When a different metric is selected via 406, the metric shown for the target instrument is adjusted to that metric while the metric selected from 426 remains the same. Similar functionality may be used/applied in connection with any (or all) of the instruments included in the related instrument list 404.

While the sparkline and the heatmap values may show the same metric or values in some examples. In certain example embodiments, the sparkline may also be individually selectable so that a different metric may be used for the spark line than that for the heatmap values. This may be applied to the target instrument shown in 402, the related instruments shown in list 404, or a combination thereof. This can thus allow for the sparkline 416 to display data for one metric while another is displayed as part of heatmap 412.

In certain example embodiments, the sparkline 416 may be based on market level data (as opposed to data that is just related to a given instrument). For example, the total volume of the market that day, or data for a given index (e.g., the S&P500). Such information may provide additional contextual data for reviewing users.

In certain example embodiments, a GUI may include multiple target instruments. For example, multiple instruments with multiple alerts may each be selected as a target instrument.

### Description of FIGS. 5-7

FIGS. 5-7 are screen shots showing different features of an example graphical user interface 550 according to certain example embodiments.

The screenshots of GUI 550 may correspond to the functionality shown in FIG. 4. The screenshots of GUI 550 may also correspond to functionality from FIG. 3. For example, a user may expand 350 from FIG. 3 to show the view shown in FIGS. 5-7 (e.g., 350 corresponds to the expanded view shown in 550).

GUI 550 includes a target instrument window 500 (e.g., the instrument that is linked to the alert that was generated) for the target instrument (CAD3M). Also included is a related instrument window 502 that includes each instrument that the selected entity (Account 11192 in the example shown in FIG. 5) has activity during a defined time period (Jun. 7, 2022-Jun. 21, 2022 in the example shown in FIG. 5).

The related instrument window 502 includes color coding 512 to identify the type of relationship that each instrument has to the target instrument. Thus, for example, green can represent instruments of the same product family, orange being an associated instrument, purple being a correlated instrument, and gray being an unknown relationship. In some examples, a user may filter the instruments based on relationship and/or may remove/hide (or even add) instruments from the related instrument window 502. In some embodiments, such a selection may be performed via a drop-down menu that is associated the “relationship type” parameter 522. In some embodiments, clicking on a given color will remove instruments (or only display instruments of that particular type) with that corresponding type of relationship from the related instrument window 502.

Each instrument that is included in the related instrument window 502 and the target instrument window 500 may be displayed with its ticker (e.g., CAD3M), its description (e.g., 3M 24 HR Copper), the origin data source or exchange (e.g., LME), and the summary value for the selected metric (e.g., $9,406,338.00 for the total value traded metric). Note that in some examples, the same ticker may be traded on multiple exchanges and thus may show up twice. In some examples, the data for a single ticker can be obtained from multiple different sources, and then may be combined into a single instrument or single data point for that instrument. In some examples, this may function the same or similar to groups (discussed elsewhere herein).

In certain examples, some instruments or products may be grouped together. As an illustrative example, Brent Crude Monthly financial futures (an instrument) can be grouped, or all instruments can be grouped under a single product (Brent Crude). Such instruments may be presented in a form within the GUI that allows for expanding/collapsing the group instruments/etc. As another example, each of the monthly COMEX copper futures shown in 502 can be grouped under one instrument group. In some examples, multiple different groups may be used under a single group. For example, a metals groups may include copper and nickel groups, with each of those groups including various futures contracts for that respective metal. Users can then optionally expand/contract a potentially long list of an entity's active instruments. In some examples, groups may be manually generated, automatically generated, or semi-automatically generated (e.g., automatically generated and the modified based on additional user input).

Note that when such instruments are grouped together, the GUI elements related summary data and heat map values may be based on the group rather than individual members of that group.

Also included in the related instrument window is a notification icon 514 that indicates that there is an alert for the related instrument for this entity, within the defined time period.

Also included in GUI 550 is the sparkline window 510 that includes a sparkline 530 for the target instrument and sparklines 532 for each related instrument from the related instrument window 502. Users can select which metric to show for these spark lines. A user can adjust which metric is displayed for the spark line for the target instrument and/or the related instruments. The metric may be one metric for the target instrument and another for the related instrument. This allows users to dynamically adjust what metrics are displayed in the spark lines-even as other metrics may be concurrently displayed elsewhere as part of the GUI 550 (e.g., which may be displayed for a heat map and/or part of the instrument list windows 500/502).

Heat map 508 displays data for the selected metric (from 520) for the target instrument. Also included in this heat map are icons 509 that indicate, along the shown timeline, when alerts for the target instrument for the currently selected entity (e.g., account) have occurred. The alert that is currently focused may also be highlighted within window 508. In some examples, if multiple alerts are close together in time, then the alert icon can be displayed with a number indicating the total number of alerts for that instance of time (e.g., June 21 as shown in FIG. 5 has 4 alerts that have been grouped together).

Heat map 506 similarly displays the values for the selected metric from 520 for the related instruments. In some examples, alerts for those related instruments may also be displayed within heat map 506.

In certain example embodiments, users can dynamically change the time period for the heatmaps to provide a broader or more narrow view of the underlying data.

In some examples, clicking on any of the alerts in 508 (or elsewhere in 550) will open that corresponding alert and the process discussed herein will be repeated for that alert. In certain example embodiments, when data related to an alert is loaded for the GUI the time range may default to 1 day (which may be subsequently modified by a user as needed).

In some examples, users can click or select a portion of the heat map to automatically drill down to that selected portion. For example, if a user selected June 16 from the graph in heat map window 508, then a heatmap of data for just June 16 will be generated for heat map window 508. In some examples, heat map window 506 will likewise be adjusted, in other examples it may stay at a different time span. Note that in certain example embodiments, the alignment of the timelines can be an advantage for users that are using system. For example, in investigating alerts and the data related thereto, it can be important to identifying coordination and synchronized activity. The alignment of the timelines can thus be an advantage in some examples.

Users can change which metric is the subject of the heatmaps, sparklines, and summary by selecting dropdown 520. FIG. 6 shows an example list 600 of different metrics for which data may be displayed. When a new metric is selected, then the data for each of the views in GUI 550 may be regenerated or otherwise displayed for that newly selected metric.

In certain examples, if an override has been applied to a given instrument (e.g., the target instrument) then the data for that instrument may not be adjusted. Rather, the other instruments may be adjusted. This may allow users to more quickly and efficiently view the target instrument in comparison to the related instruments.

FIG. 7 shows the result of selecting “Cumulative Net Value Traded” metric from FIG. 6. As shown in FIG. 7, all of the various windows of the GUI 550 are regenerated and updated based on that newly selected metric.

In certain example embodiments, users may select multiple different override metrics and view those side by side with the related instruments. Thus, for example, a view of the Cumulative Net Value Traded and the Value Traded may be concurrently displayed for the CAD3M instrument. These metrics may be concurrently displayed with a third metric for the related instruments.

### Description of FIG. 8

FIG. 8 is a block diagram of an example computing device 800 (which may also be referred to, for example, as a “computing device,” “computer system,” or “computing system”) according to some embodiments. In some embodiments, the computing device 800 includes one or more of the following: one or more processors 802 (which may be referred to as “hardware processors” or individually as a “hardware processor”); one or more memory devices 804; one or more network interface devices 806; one or more display interfaces 808; and one or more user input adapters 810. Additionally, in some embodiments, the computing device 800 is connected to or includes a display device 812. As will explained below, these elements (e.g., the processors 802, memory devices 804, network interface devices 806, display interfaces 808, user input adapters 810, display device 812) are hardware devices (for example, electronic circuits or combinations of circuits) that are configured to perform various different functions for the computing device 800. In some embodiments, these components of the computing device 800 may be collectively referred to as computing resources (e.g., resources that are used to carry out execution of instructions and include the processors (one or more processors 802), storage (one or more memory devices 804), and I/O (network interface devices 806, one or more display interfaces 808, and one or more user input adapters 810). In some instances, the term processing resources may be used interchangeably with the term computing resources. In some embodiments, multiple instances of computing device 800 may arranged into a distributed computing system.

In some embodiments, each or any of the processors 802 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 802 uses an instruction set architecture such as x86 or Advanced RISC Machine (ARM).

In some embodiments, each or any of the memory devices 804 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 802). Memory devices 804 are examples of non-transitory computer-readable storage media.

In some embodiments, each or any of the network interface devices 806 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), LTE Pro, Fifth Generation New Radio (5G NR) and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, data is communicated over an electronic data network. An electronic data network includes implementations where data is communicated from one computer process space to computer process space and thus may include, for example, inter-process communication, pipes, sockets, and communication that occurs via direct cable, cross-connect cables, fiber channel, wired and wireless networks, and the like. In certain examples, network interface devices 806 may include ports or other connections that enable such connections to be made and communicate data electronically among the various components of a distributed computing system.

In some embodiments, each or any of the display interfaces 808 is or includes one or more circuits that receive data from the processors 802, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 812, which displays the image data. Alternatively, or additionally, in some embodiments, each or any of the display interfaces 808 is or includes, for example, a video card, video adapter, or graphics processing unit (GPU).

In some embodiments, each or any of the user input adapters 810 is or includes one or more circuits that receive and process user input data from one or more user input devices (not shown in FIG. 8) that are included in, attached to, or otherwise in communication with the computing device 800, and that output data based on the received input data to the processors 802. Alternatively, or additionally, in some embodiments each or any of the user input adapters 810 is or includes, for example, a PS/2 interface, a USB interface, a touchscreen controller, or the like; and/or the user input adapters 810 facilitates input from user input devices (not shown in FIG. 8) such as, for example, a keyboard, mouse, trackpad, touchscreen, etc.

In some embodiments, the display device 812 may be a Liquid Crystal Display (LCD) display, Light Emitting Diode (LED) display, or other type of display device. In embodiments where the display device 812 is a component of the computing device 800 (e.g., the computing device and the display device are included in a unified housing), the display device 812 may be a touchscreen display or non-touchscreen display. In embodiments where the display device 812 is connected to the computing device 800 (e.g., is external to the computing device 800 and communicates with the computing device 800 via a wire and/or via wireless communication technology), the display device 812 is, for example, an external monitor, projector, television, display screen, etc.

In various embodiments, the computing device 800 includes one, or two, or three, four, or more of each or any of the above-mentioned elements (e.g., the processors 802, memory devices 804, network interface devices 806, display interfaces 808, and user input adapters 810). Alternatively, or additionally, in some embodiments, the computing device 800 includes one or more of: a processing system that includes the processors 802; a memory or storage system that includes the memory devices 804; and a network interface system that includes the network interface devices 806. Alternatively, or additionally, in some embodiments, the computing device 800 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processors 802 and the network interface devices 806; or the single SoC (or the multiple SoCs) may include the processors 802, the network interface devices 806, and the memory devices 804; and so on. The computing device 800 may be arranged in some embodiments such that: the processors 802 include a multi or single-core processor; the network interface devices 806 include a first network interface device (which implements, for example, WiFi, Bluetooth, NFC, etc.) and a second network interface device that implements one or more cellular communication technologies (e.g., 3G, 4G LTE, CDMA, etc.); the memory devices 804 include RAM, flash memory, or a hard disk. As another example, the computing device 800 may be arranged such that: the processors 802 include two, three, four, five, or more multi-core processors; the network interface devices 806 include a first network interface device that implements Ethernet and a second network interface device that implements WiFi and/or Bluetooth; and the memory devices 804 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the surveillance system 100, alert module 118, data processing module 122, GUI module 120, clients 106, each of which will be referred to individually for clarity as a “component” for the remainder of this paragraph, are implemented using an example of the computing device 800 of FIG. 8. In such embodiments, the following applies for each component: (a) the elements of the 800 computing device 800 shown in FIG. 8 (i.e., the one or more processors 802, one or more memory devices 804, one or more network interface devices 806, one or more display interfaces 808, and one or more user input adapters 810), or appropriate combinations or subsets of the foregoing) are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the memory devices 804 (e.g., in various embodiments, in a volatile memory device such as a RAM or an instruction register and/or in a non-volatile memory device such as a flash memory or hard disk) and all actions described herein as performed by the software modules are performed by the processors 802 in conjunction with, as appropriate, the other elements in and/or connected to the computing device 800 (i.e., the network interface devices 806, display interfaces 808, user input adapters 810, and/or display device 812); (c) alternatively or additionally, to the extent it is described herein that the component processes and/or otherwise handles data, in some embodiments, such data is stored in the memory devices 804 (e.g., in some embodiments, in a volatile memory device such as a RAM and/or in a non-volatile memory device such as a flash memory or hard disk) and/or is processed/handled by the processors 802 in conjunction, as appropriate, the other elements in and/or connected to the computing device 800 (i.e., the network interface devices 806, display interfaces 808, user input adapters 810, and/or display device 812); (d) alternatively or additionally, in some embodiments, the memory devices 802 store instructions that, when executed by the processors 802, cause the processors 802 to perform, in conjunction with, as appropriate, the other elements in and/or connected to the computing device 800 (i.e., the memory devices 804, network interface devices 806, display interfaces 808, user input adapters 810, and/or display device 812), each or any combination of actions described herein as performed by the component and/or by any software modules described herein as included within the component.

The hardware configurations shown in FIG. 8 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 8, (e) via other hardware arrangements, architectures, and configurations, and/or via combinations of the technology described in (a) through (e).

### Technical Advantages of Described Subject Matter

In certain example embodiments, a system is provided that generates a graphical user interface that provides an entity level view that allows users to dynamically change heatmap values and zooming in and out of areas of interest on the heatmap to more quickly assess an entity's multi-instrument actions in order to mitigate concern and/or identify areas of activity that require more focused analysis.

In certain examples the entity view can act as a higher-level scoping and targeting tool as well as an entry point for the ‘comparison view’ which allows users to use other investigative tools (e.g., based on as Spread and Depth metrics) for further investigation. Accordingly, the techniques discussed herein allow for presenting/arranging information in a manner that allows for more quickly identifying false-positives (or true-positives).

In certain examples, a comprehensive view of an entity's activity may be provided while also allowing for differing data views. For example, different metrics may be concurrently viewed/selected in order for an investigator to better analyze complex data structures.

In certain example embodiments, the techniques herein can be used to address so-called alert fatigue that can occur when too many alerts (e.g., level 1 alerts) are being generated. When too many alerts are generated reviewers can become desensitized or the like to the alerts. Incorporating the features described herein into the graphical user interface allows for adding additional filters and/or views for the data related to alerts. This includes, for example, displaying target and related views to the user in the GUI. This also may include displaying a heatmap to give users a visual representation that incorporates data from one or more (e.g., multiple) resources for which a given entity has transacted.

### Selected Terminology

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Whenever it is stated herein that a hardware element (e.g., a processor, a network interface, a display interface, a user input adapter, a memory device, or other hardware element), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can therefore be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

### Additional Applications of Described Subject Matter

Although process steps, algorithms or the like, including without limitation with reference to FIG. 2, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A computer system comprising:
non-transitory data storage configured to store: 1) data for a plurality of resources, and 2) data that is based on data transaction request messages of how data transaction requests have been processed in connection with each one of the plurality of resources, with each corresponding one of the data transaction request messages associated with a transacting identifier that identifies a party involved with the corresponding one of the data transaction request messages; and
a processing system comprising instructions that, when executed by at least one hardware processor of the processing system, cause the at least one hardware processor to perform operations comprising:
processing an alert event that is associated with a target resource of the plurality of resources, wherein the alert event is linked to the transacting identifier that identifies the party involved with the corresponding one of the data transaction request messages on which the alert event is based;
selecting an entity that is associated with one or more transacting identifiers, which includes the transacting identifier associated with the alert event;
generating an entity level graphical user interface that is used to concurrently display a plurality of views that comprise:
(1) a target resource view that includes data for a first metric for the target resource; and
(2) a related resource view that includes data for the first metric for each one of a plurality of related resources for which any of transacting identifiers that are associated with the entity have activity.

2. The computer system of claim 1, wherein the operations further comprise:
receiving an override selection for a second metric; and
modifying the target resource view to include data for the second metric, while maintaining the related resource view that includes data for the first metric.

3. The computer system of claim 1, wherein the plurality of views further comprises (3) a heatmap with different colors that displays data associated with each of the target resource and the plurality of related resources for the first metric.

4. The computer system of claim 3, wherein the operations further comprise:
receiving an instruction to modify a time period for the heatmap; and
dynamically updating the heatmap for the modified time period, wherein a number of time periods for the heatmap remains unchanged.

5. The computer system of claim 1, wherein the plurality of views further comprises (3) a sparkline for each of the target resource and the plurality of related resources for the first metric.

6. The computer system of claim 5, wherein the operations further comprise:
receiving an instruction to modify the sparkline for at least one of the target resource and the plurality of related resources from the first metric to a second metric; and
dynamically updating the sparkline for the at least one of the target resource and the plurality of related resources to the second metric.

7. The computer system of claim 5, wherein the plurality of views further comprises (4) a heatmap with different colors that displays data associated with each of the target resource and the plurality of related resources for the first metric.

8. The computer system of claim 1, wherein the plurality of views further comprises (3) a summary value for each of the target resource and the plurality of related resources for the first metric.

9. The computer system of claim 8, wherein the operations further comprise:
receiving an instruction to modify a time span; and
dynamically updating the summary value based on the modified time span to be for data for the at least one of the target resource and the plurality of related resources that is within the time span.

10. The computer system of claim 1, wherein the operations further comprise:
receiving an instruction to add a further transacting identifier to the selected entity; and
dynamically updating the entity level graphical user interface based on data that is associated with the further transacting identifier.

11. A method of generating a graphical user interface for entity activity based on an alert, the method comprising:
storing 1) data for a plurality of resources, and 2) data that is based on data transaction request messages of how data transaction requests have been processed in connection with each one of the plurality of resources, with each corresponding one of the data transaction request messages associated with a transacting identifier that identifies a party involved with the corresponding one of the data transaction request messages;
processing an alert event that is associated with a target resource of the plurality of resources, wherein the alert event is linked to the transacting identifier that identifies the party involved with the corresponding one of the data transaction requests messages on which the alert event is based;
selecting an entity that is associated with one or more transacting identifiers, which includes the transacting identifier associated with the alert event;
generating an entity level graphical user interface that is used to concurrently display a plurality of views that comprise:
(1) a target resource view that includes data for a first metric for the target resource; and
(2) a related resource view that includes data for the first metric for each one of a plurality of related resources for which any of transacting identifiers that are associated with the entity have activity.

12. The method of claim 11, further comprising:
receiving an override selection for a second metric; and
modifying the target resource view to include data for the second metric, while maintaining the related resource view that includes data for the first metric.

13. The method of claim 11, wherein the plurality of views further comprises (3) a heatmap with different colors that displays data associated with each of the target resource and the plurality of related resources for the first metric.

14. The method of claim 11, wherein the plurality of views further comprises (3) a sparkline for each of the target resource and the plurality of related resources for the first metric.

15. The method of claim 14, wherein the plurality of views further comprises (4) a heatmap with different colors that displays data associated with each of the target resource and the plurality of related resources for the first metric.

16. A non-transitory computer readable storage medium storing computer readable instructions that are configured to be executed by at least one hardware processor that is coupled to a data storage system that is configured to store 1) data for a plurality of resources, and 2) data that is based on data transaction request messages of how data transaction requests have been processed in connection with each one of the plurality of resources, with each corresponding one of the data transaction request messages associated with a transacting identifier that identifies a party involved with the corresponding one of the data transaction request messages, the stored computer readable instructions configured to perform operations comprising:
processing an alert event that is associated with a target resource of the plurality of resources, wherein the alert event is linked to the transacting identifier that identifies the party involved with the corresponding one of the data transaction requests messages on which the alert event is based;
selecting an entity that is associated with one or more transacting identifiers, which includes the transacting identifier associated with the alert event;
generating an entity level graphical user interface that is used to concurrently display a plurality of views that comprise:
(1) a target resource view that includes data for a first metric for the target resource; and
(2) a related resource view that includes data for the first metric for each one of a plurality of related resources for which any of transacting identifiers that are associated with the entity have activity.

17. The non-transitory computer readable storage medium of claim 16, wherein the operations further comprise:
receiving an override selection for a second metric; and
modifying the target resource view to include data for the second metric, while maintaining the related resource view that includes data for the first metric.

18. The non-transitory computer readable storage medium of claim 16, wherein the plurality of views further comprises (3) a heatmap with different colors that displays data associated with each of the target resource and the plurality of related resources for the first metric.

19. The non-transitory computer readable storage medium of claim 18, wherein the plurality of views further comprises (4) a sparkline for each of the target resource and the plurality of related resources for the first metric.

20. The non-transitory computer readable storage medium of claim 19, wherein the plurality of views further comprises (5) a summary value for each of the target resource and the plurality of related resources for the first metric.
